(19) United States
(12) Patent Application Publication
(10) Pub. No.: US 2026/0010062 A1
(43) Pub. Date: Jan. 8, 2026

(54) OPTICAL ENGINE ADJUSTMENT MECHANISM

(71) Applicant: ViewSonic International Corporation, New Taipei City (TW)

(72) Inventors: Jia-Shin Tsai, New Taipei City (TW); Shun-Chang Chen, New Taipei City (TW); Kun-Tsang Yang, New Taipei City (TW)

(73) Assignee: ViewSonic International Corporation, New Taipei City (TW)

(21) Appl. No.: 19/188,028

(22) Filed: Apr. 24, 2025

(30) Foreign Application Priority Data
Jul. 4, 2024 (TW) 113125085

(51) Int. Cl. G03B 21/20; G03B 21/14

(52) U.S. Cl. CPC G03B 21/2046; G03B 21/145; G03B 21/2033

(57) ABSTRACT

An optical engine adjustment mechanism includes a base, an optical engine bracket, and an adjustment rod. The optical engine bracket has a fixing portion, an installation portion, and an adjustment portion. The optical engine bracket is fixed to the base through the fixing portion. The installation portion is used for mounting an optical engine thereon. The adjustment portion includes a threaded hole. The adjustment rod includes a connecting portion, a threaded portion, and a rotating portion. The adjustment rod is pivotally connected to the base through the connecting portion. The threaded portion is engaged with the threaded hole. By rotating the rotating portion to turn the threaded portion, the optical engine bracket tilts away from or toward the base.

### BACKGROUND OF THE INVENTION

### 1. Field of the Invention

The present invention relates to a fixing structure for a projector optical engine, and more particularly to an adjustment mechanism for the projector optical engine.

### 2. Description of the Prior Art

A projector is generally designed so that when placed horizontally, the image projected by its optical engine remains properly aligned. However, during the assembly of the projector, manufacturing tolerances of individual components lead to accumulated assembly tolerances, which are inevitable. In addition, the optical engine is typically provided as a module, and its own manufacturing process also involves tolerances. Therefore, the accumulated assembly tolerances combined with the tolerances of the optical engine itself will, in principle, cause the projected image of the assembled projector to have a certain tilt angle. When the tilt angle exceeds the product specifications, the product is generally deemed non-compliant, leading to an increasing production costs.

### SUMMARY OF THE INVENTION

In view of the issues in the prior art, an objective of the present invention is to provide an optical engine adjustment mechanism that utilizes an adjustable optical engine bracket to fine-tune the projection angle of the optical engine.

An optical engine adjustment mechanism of an embodiment according to the invention includes a base, an optical engine bracket, and an adjustment rod. The optical engine bracket includes a fixing portion, an installation portion, and an adjustment portion. The optical engine bracket is fixed to the base through the fixing portion. The installation portion is used for mounting an optical engine thereon. The adjustment portion includes a threaded hole. The adjustment rod includes a connecting portion, a threaded portion, and a rotating portion. The adjustment rod is pivotally connected to the base through the connecting portion. The threaded portion is engaged with the threaded hole. By rotating the rotating portion to turn the threaded portion, the optical engine bracket tilts away from or toward the base. Thus, by tilting the optical engine bracket, the projection angle of the optical engine mounted on the optical engine bracket can be easily adjusted. This effectively resolves the issue in the prior art where the image distortion angle of the projected image exceeds product specifications, leading to the projector being deemed non-compliant and increasing production costs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a projector according to a first embodiment.

FIG. 2 is a partially-exploded view of the projector in FIG. 1.

FIG. 3 is a schematic diagram illustrating that an optical engine and an optical engine adjustment mechanism are disposed on a lower casing of a projector casing in FIG. 1.

FIG. 4 is an exploded view of the optical engine, the optical engine adjustment mechanism, and the lower casing in FIG. 3.

FIG. 5 is a sectional view along the line X-X in FIG. 3.

FIG. 6 is a schematic diagram illustrating that an optical engine bracket deflects away from a base in FIG. 5.

FIG. 7 is a schematic diagram illustrating that the optical engine bracket deflects toward the base in FIG. 5.

FIG. 8 is a schematic diagram illustrating the structural configuration in FIG. 3 in another viewpoint.

### DETAILED DESCRIPTION

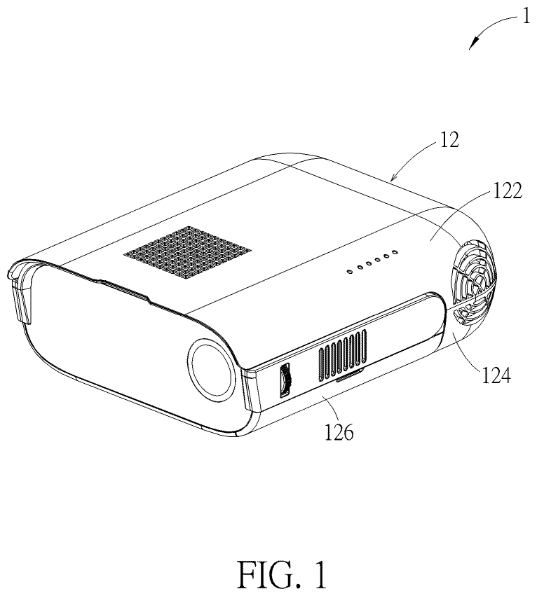

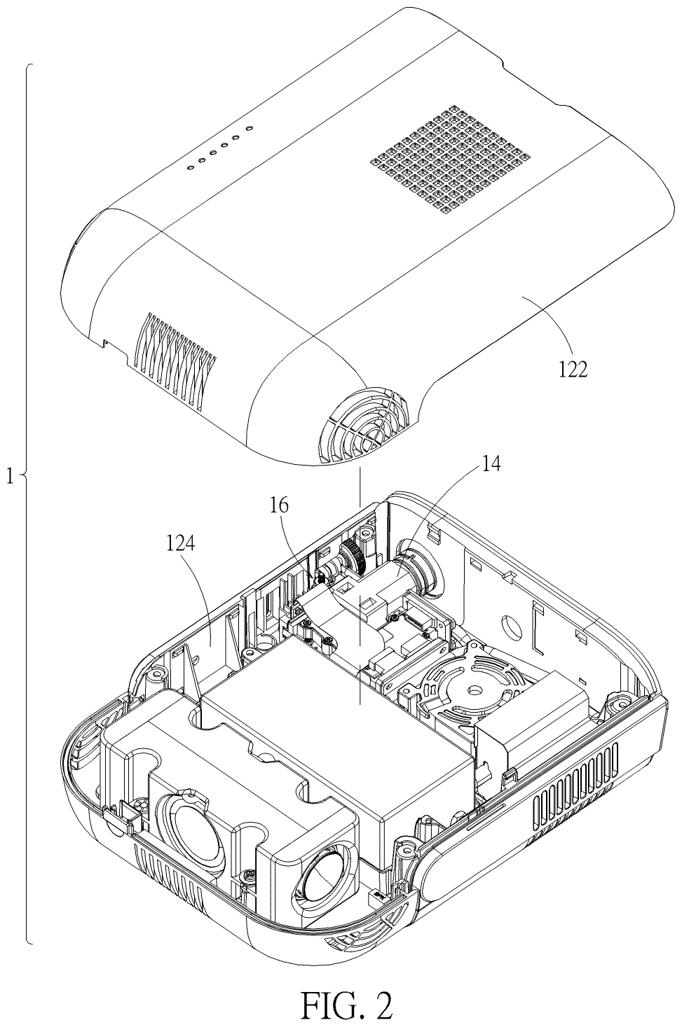

Please refer to FIG. 1 and FIG. 2. According to a first embodiment, a projector 1 includes a projector housing 12, and an optical engine 14, an optical engine adjustment mechanism 16, and other components accommodated therein. The optical engine 14 is mounted on the optical engine adjustment mechanism 16. The projection angle of the optical engine 14 can be adjusted by operating the optical engine adjustment mechanism 16, as described later.

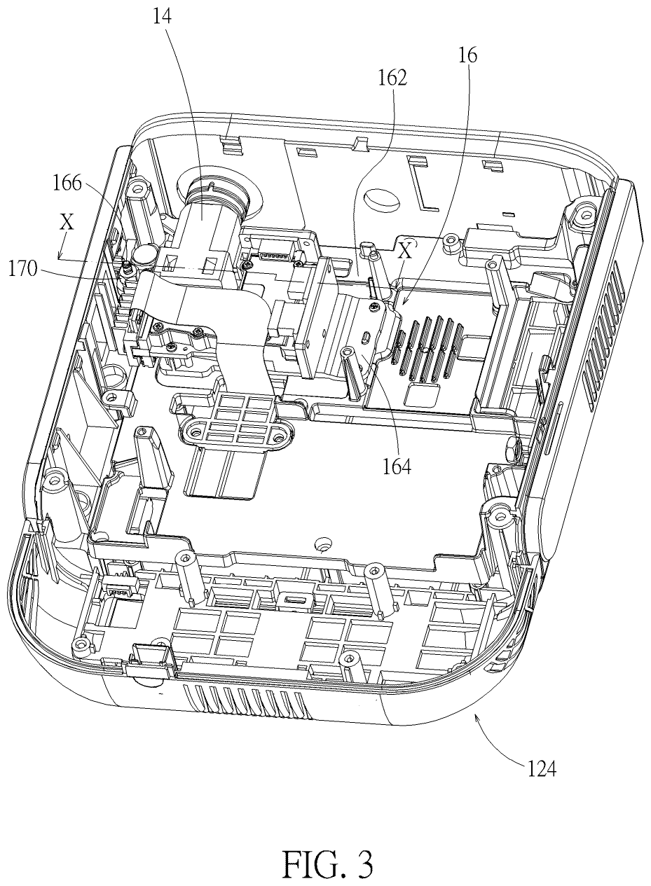

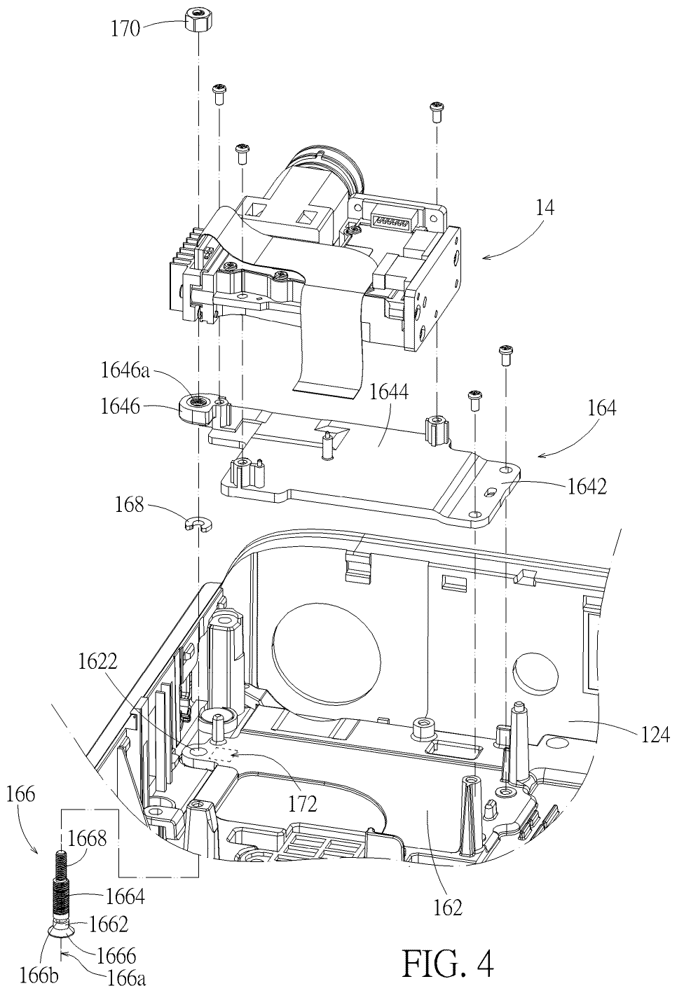

Please also refer to FIG. 3 and FIG. 4. Therein, FIG. 3 shows partial internal components of the projector 1, and FIG. 4 is an exploded view of the components shown in FIG. 3. The projector housing 12 includes an upper cover 122 and a lower cover 124, which are assembled together to form an accommodation space for housing the optical engine 14, the optical engine adjustment mechanism 16, and other components. The optical engine adjustment mechanism 16 includes a base 162, an optical engine bracket 164, and an adjustment rod 166. The optical engine bracket 164 includes a fixing portion 1642, an installation portion 1644, and an adjustment portion 1646. The optical engine bracket 164 is fixed to the base 162 through the fixing portion 1642 (in this embodiment, secured by screws). The installation portion 1644 is used for mounting the optical engine 14 (in this embodiment, the optical engine 14 is mounted on the installation portion 1644 by screws). The adjustment portion 1646 includes a threaded hole 1646a, which can be implemented, for example, but not limited to, by embedding a threaded post into the main body of the optical engine bracket 164. Therein, in this embodiment, the lower cover 124 is a combined housing. The base 162 is structurally integrated as a part of the lower cover 124. Therefore, logically, the optical engine adjustment mechanism 16 can also be considered as being disposed on the lower cover 124.

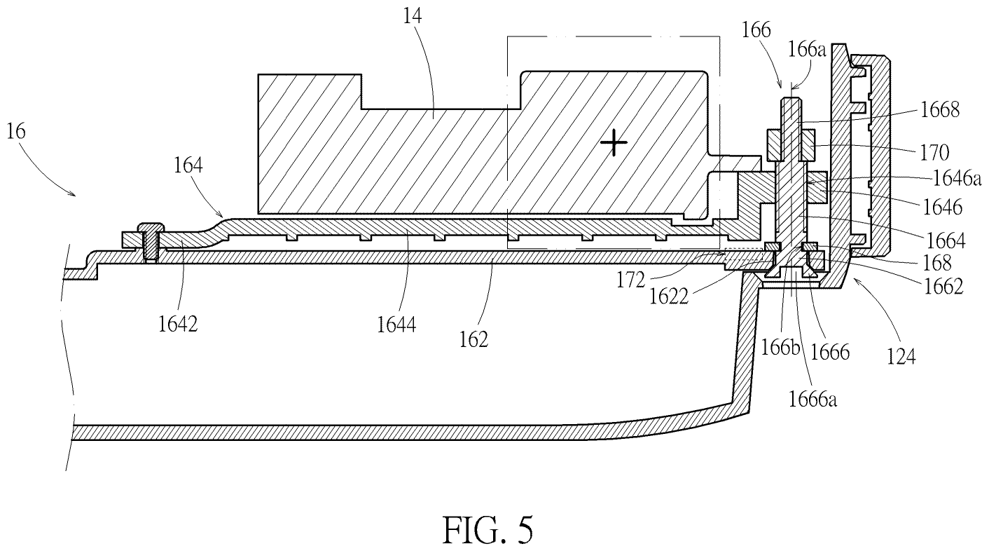

Please also refer to FIG. 5; therein, in FIG. 5, for the sake of simplifying the illustration, the optical engine 14 is represented by a single structural component, and its specific structure may correspond to a conventional optical engine module, such as, but not limited to, an RGB LED optical engine, which will not be described in addition. Furthermore, in FIG. 5, the optical axis of the lens of the optical engine 14 is indicated by a cross mark in the figure. The adjustment rod 166 is generally rod-shaped and extends along an axis 166a (represented by a chain line in FIG. 4 and FIG. 5). The adjustment rod 166 includes a connecting portion 1662, a first threaded portion 1664, and a rotating portion 1666, wherein the first threaded portion 1664 and the rotating portion 1666 are positioned on opposite sides of the connecting portion 1662. The adjustment rod 166 is pivotally connected to the base 162 through the connecting portion 1662, while the first threaded portion 1664 is engaged with the threaded hole 1646a of the adjustment portion 1646. The rotating portion 1666 can be rotated to cause the entire adjustment rod 166 to rotate. Therein, the adjustment rod 166 can rotate relative to the base 162 without moving vertically relative to the base 162 (in the perspective of FIG. 5). In this embodiment, the base 162 includes a through hole 1622, through which the connecting portion 1662 extends. The optical engine adjustment mechanism 16 further includes a retaining ring 168 (e.g., but not limited to, a C-type retaining ring), which is retained within an annular groove 166b of the adjustment rod 166. The outer diameter of the retaining ring 168 and the outer diameter of the rotating portion 1666 are both greater than the outer diameter of the connecting portion 1662, such that the base 162 (at the through hole 1622) is sandwiched between the retaining ring 168 and the rotating portion 1666, thereby achieving the pivotal connection between the adjustment rod 166 and the base 162. In practice, the pivotal connection between the adjustment rod 166 and the base 162 can also be implemented using other structures. For example, a bearing can be disposed within the through hole 1622, with the connecting portion 1662 engaged within the inner ring of the bearing.

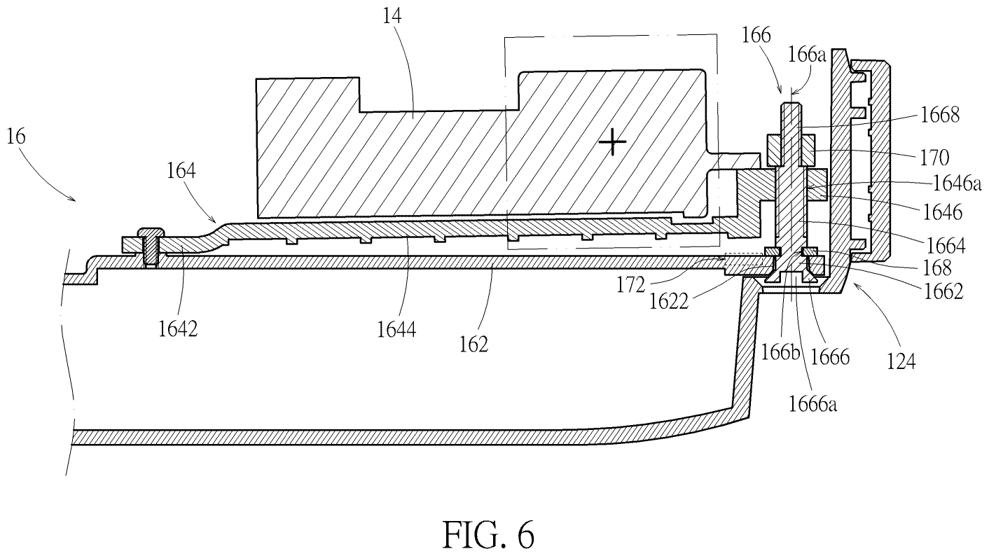

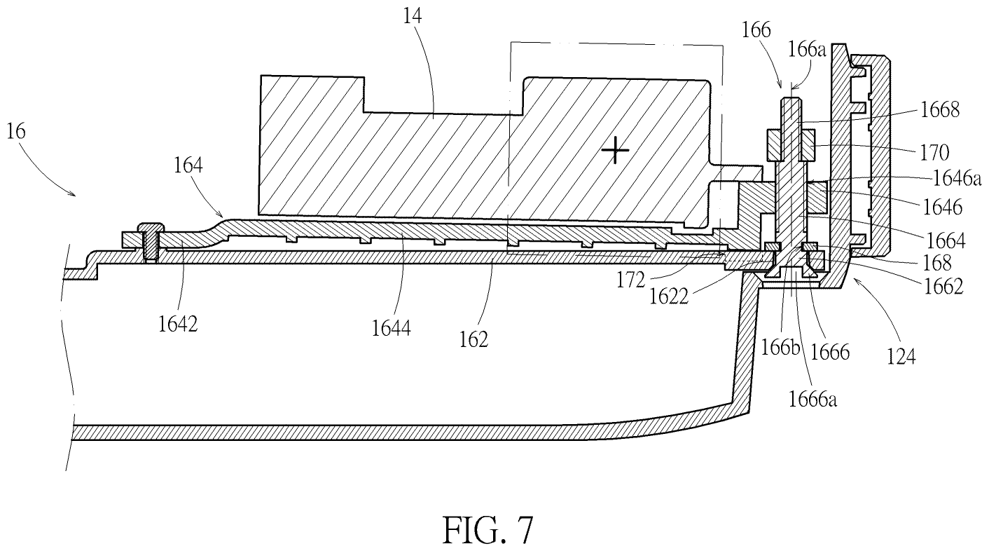

As shown in FIG. 5, in this embodiment, in the optical engine bracket 164, the installation portion 1644 is positioned between the fixing portion 1642 and the adjustment portion 1646. The optical engine bracket 164 is connected to the base 162 only through the fixing portion 1642 and the adjustment portion 1646. Therefore, as the first threaded portion 1664 is engaged with the threaded hole 1646a, rotating the rotating portion 1666 causes the first threaded portion 1664 to rotate, thereby making the optical engine bracket 164 tilt away from or toward the base 162 (with the fixing portion 1642 serving as the fixed end and the adjustment portion 1646 serving as the movable end). For example, rotating the rotating portion 1666 in a direction (e.g., in a counterclockwise direction when viewed from bottom to top in FIG. 5) causes the adjustment portion 1646 to move away from the base 162, i.e., making the optical engine bracket 164 tilt away from the base 162 in a counterclockwise direction, as shown by FIG. 6. Conversely, rotating the rotating portion 1666 in the opposite direction (e.g., in a clockwise direction when viewed from bottom to top in FIG. 5) causes the adjustment portion 1646 to move toward the base 162, thereby making the optical engine bracket 164 tilt toward the base 162 in a clockwise direction, as shown in FIG. 7.

Therein, in FIG. 5 to FIG. 7, the projection range of the optical engine 14 is represented by a chain line frame. Assuming that the projection range in FIG. 5 is presented horizontally and vertically aligned, then in FIG. 6, as the optical engine 14 tilts away from the base 162 along with the optical engine bracket 164, the projection range in FIG. 6 also rotates counterclockwise by a small angle relative to the optical axis of the optical engine 14. Similarly, in FIG. 7, as the optical engine 14 tilts toward the base 162 along with the optical engine bracket 164, the projection range in FIG. 7 also rotates clockwise by a small angle relative to the optical axis of the optical engine 14. Accordingly, in actual use, the manufacturer of the projector 1 can adjust the projection angle (corresponding to the projection range here) of the optical engine 14 by operating the optical engine adjustment mechanism 16 before shipment, ensuring compliance with product specifications. From another perspective, the optical engine adjustment mechanism 16 provides the function of compensating for manufacturing tolerances of the components of the projector 1 as well as the accumulated assembly tolerances. Furthermore, after the projector 1 has been shipped, the user can also operate the optical engine adjustment mechanism 16 as needed to adjust the projection angle of the optical engine 14. For example, after long-term use, if the projection angle of the optical engine 14 deviates from its factory-set position due to certain reasons, the user can adjust it through the optical engine adjustment mechanism 16 to ensure that the projector 1 continues to meet the required projection conditions, thereby extending the service life of the projector 1.

In practice, the small angular range of the clockwise and counterclockwise rotation of the above projection range can be restricted by incorporating an appropriate structure. This prevents the optical engine bracket 164 from excessively tilting, which could lead to collisions with other components and cause damage. In this embodiment, as shown in FIG. 4 and FIG. 5, the optical engine adjustment mechanism 16 includes a first limiting structure 170, which is disposed on the adjustment rod 166. The adjustment portion 1646 of the optical engine bracket 164 is positioned between the first limiting structure 170 and the connecting portion 1662 of the adjustment rod 166 (or, alternatively, the portion of the base 162 adjacent to the through hole 1622). Accordingly, the first limiting structure 170 serves as an upper limit stop for the upward movement of the adjustment portion 1646 relative to the first threaded portion 1664, thereby preventing the optical engine bracket 164 from tilting away from the base 162. In this embodiment, the first limiting structure 170 is a nut, which is threadedly secured onto the adjustment rod 166. Furthermore, the adjustment rod 166 includes a second threaded portion 1668. The first threaded portion 1664 is positioned between the second threaded portion 1668 and the connecting portion 1662, wherein the outer diameter of the second threaded portion 1668 is smaller than the outer diameter of the first threaded portion 1664. The nut (i.e., the first limiting structure 170) is engaged with the second threaded portion 1668 and abuts against the first threaded portion 1664.

In practice, the configuration of the first limiting structure 170 is not limited to the aforementioned arrangement. For example, the adjustment rod 166 may not include the second threaded portion 1668, and the first limiting structure 170 (i.e., the nut) can be directly engaged with the first threaded portion 1664. The nut may also be fixed to the adjustment rod 166 using other methods, such as adhesive bonding. Additionally, the first limiting structure 170 is not limited to being implemented as a nut, and it may instead be realized as a pin or a retaining ring. Correspondingly, the adjustment rod 166 can include a lateral through-hole or an annular groove, wherein the pin is inserted into the lateral through-hole, or the retaining ring is engaged within the annular groove.

Furthermore, as shown in FIG. 4 and FIG. 5, the optical engine adjustment mechanism 16 also includes a second limiting structure 172, which is disposed on the base 162. More specifically, the second limiting structure 172 is a part of the base 162 (its position is indicated by a dashed line frame in the figures). The second limiting structure 172 is configured corresponding to the optical engine bracket 164 and serves as a lower limit stop for the downward movement of the adjustment portion 1646 relative to the first threaded portion 1664, thereby preventing the optical engine bracket 164 from tilting toward the base 162. In practice, the second limiting structure 172 may also be implemented as a separate component, which is fixed to the base 162.

In practice, the configuration of the second limiting structure 172 is not limited to the aforementioned arrangement. For example, the second limiting structure 170 may instead be implemented as a nut, which is secured onto the first threaded portion 1664 and positioned between the adjustment portion 1646 and the through hole 1622 of the base 142. The position of the nut on the first threaded portion 1664 may also be secured using adhesive or other fixation methods. Alternatively, the second limiting structure 170 may also be implemented as a pin or a retaining ring. Correspondingly, the adjustment rod 166 may include a lateral through hole or an annular groove, wherein the pin is inserted into the lateral through hole, or the retaining ring is engaged within the annular groove, such that the pin or the retaining ring is positioned between the adjustment portion 1646 and the through hole 1622 of the base 142.

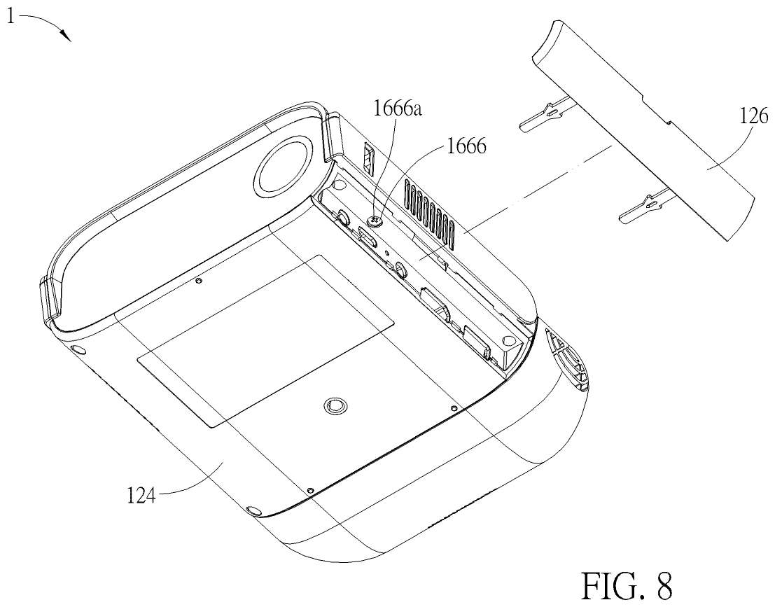

Furthermore, as shown in FIG. 5, the rotation of the adjustment rod 166 is achieved by rotating the rotating portion 1666. As shown in FIG. 8, in this embodiment, the rotating portion 1666 is exposed through the lower cover 124, allowing the user to directly rotate the rotating portion 1666. In this embodiment, the rotating portion 1666 includes a transmission structure 1666a, which is configured to engage with a hand tool for rotating the rotating portion 1666. The transmission structure 1666a is a groove structure, which may include, but is not limited to, common shapes such as slotted, Phillips, star-shaped, or hexagonal socket, etc. The user may use a suitable screwdriver to insert into the groove structure and rotate the rotating portion 1666. Furthermore, in this embodiment, the rotating portion 1666 is configured as a flat head/countersunk screw head; however, the implementation is not limited thereto. For example, the rotating portion 1666 may alternatively be protruding from the base 162. In this case, the transmission structure 1666a may instead be implemented as, for example, a hexagonal bolt head, allowing the user to still engage the transmission structure 1666a with a hand tool (e.g., using a hex socket wrench to fit onto the transmission structure 1666a) to rotate the rotating portion 1666. Alternatively, the rotating portion 1666 may be implemented as a cylindrical structure protruding from the base 162, wherein a knurled pattern is formed on the outer circumferential surface of the cylindrical structure. In this example, the transmission structure 1666a may be omitted, allowing the user to directly grip the knurled pattern by hand to rotate the rotating portion 1666.

In addition, in this embodiment, the rotating portion 1666 of the adjustment rod 166 is configured for direct rotation by the user (for example, by engaging with a hand tool or gripping manually); however, the implementation is not limited thereto. For example, the optical engine adjustment mechanism 16 can be designed such that the user rotates the rotating portion 1666 through another structure linked to the rotating portion 1666. For example, the rotating portion 1666 can be configured as a gear structure, with an additional gear assembly engaging with the rotating portion 1666, allowing the user to rotate the rotating portion 1666 by driving the gear assembly. In addition, in this embodiment, a decorative cover 126 is detachably attached to the lower cover 124 to conceal the rotating portion 1666, thereby preventing accidental contact with the rotating portion 1666 and simultaneously enhancing the aesthetic appearance of the projector 1.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical engine adjustment mechanism, comprising:
a base;
an optical engine bracket, the optical engine bracket having a fixing portion, an installation portion, and an adjustment portion, the optical engine bracket being fixed to the base through the fixing portion, the installation portion being used for mounting an optical engine thereon, the adjustment portion includes a threaded hole; and
an adjustment rod, the adjustment rod includes a connecting portion, a first threaded portion, and a rotating portion, the adjustment rod being pivotally connected to the base through the connecting portion, the first threaded portion being engaged with the threaded hole, wherein by rotating the rotating portion to rotate the first threaded portion, the optical engine bracket tilts away from or toward the base.

2. The optical engine adjustment mechanism according to claim 1, wherein the base includes a through hole, through which the connecting portion extends, and the first threaded portion and the rotating portion are positioned on opposite sides of the connecting portion.

3. The optical engine adjustment mechanism according to claim 2, further comprising a retaining ring, wherein an outer diameter of the rotating portion and an outer diameter of the retaining ring are both greater than an outer diameter of the connecting portion, the retaining ring is retained on the adjustment rod, and the base is sandwiched between the retaining ring and the rotating portion.

4. The optical engine adjustment mechanism according to claim 1, further comprising a first limiting structure, wherein the first limiting structure is disposed on the adjustment rod, and the adjustment portion is positioned between the first limiting structure and the connecting portion.

5. The optical engine adjustment mechanism according to claim 4, wherein the first limiting structure is a nut, which is threadedly secured onto the adjustment rod.

6. The optical engine adjustment mechanism according to claim 5, wherein the adjustment rod includes a second threaded portion, the first threaded portion is positioned between the second threaded portion and the connecting portion, an outer diameter of the second threaded portion is smaller than an outer diameter of the first threaded portion, and the nut is engaged with the second threaded portion and abuts against the first threaded portion.

7. The optical engine adjustment mechanism according to claim 1, wherein the rotating portion includes a transmission structure, which is configured to be engaged with a hand tool for rotating the rotating portion.

8. The optical engine adjustment mechanism according to claim 1, further comprising a second limiting structure, wherein the second limiting structure is disposed on the base or the adjustment rod, to prevent the optical engine bracket from tilting toward the base.

9. The optical engine adjustment mechanism according to claim 1, wherein the installation portion is positioned between the fixing portion and the adjustment portion.

10. The optical engine adjustment mechanism according to claim 1, wherein the base is a projector housing, and the rotating portion is exposed through the projector housing.
